(19) United States
(12) Patent Application Publication
(10) Pub. No.: US 2026/0129078 A1
(43) Pub. Date: May 7, 2026

(54) PRIORITY DETERMINATION SYSTEM AND PRIORITY DETERMINATION METHOD

(71) Applicant: Panasonic Automotive Systems Co., Ltd., Kanagawa (JP)

(72) Inventors: Shoichiro SEKIYA, Osaka (JP); Yuishi TORISAKI, Osaka (JP); Ryo WATANABE, Osaka (JP); Tomoyuki HAGA, Nara (JP)

(73) Assignee: Panasonic Automotive Systems Co., Ltd., Kanagawa (JP)

(21) Appl. No.: 19/346,960

(22) Filed: Oct. 1, 2025

(30) Foreign Application Priority Data
Nov. 1, 2024 (JP) 2024-193032

(51) Int. Cl. H04L 9/40

(52) U.S. Cl. CPC H04L 63/1491; H04L 63/1433

(57) ABSTRACT

A priority determination system includes: an obtainer that obtains vulnerability information concerning a vulnerability of a monitoring target; an inquiry component that obtains, based on the vulnerability information, configuration information indicating a configuration of a honeypot and observation information from observation performed by the honeypot; an analysis determiner that determines a priority of response to the vulnerability by analyzing the configuration information and the observation information; and an outputter that outputs a result of the determination performed by the analysis determiner.

### CROSS REFERENCE TO RELATED APPLICATION

The present application is based on and claims priority of Japanese Patent Application No. 2024-193032 filed on November 01, 2024.

### FIELD

The present disclosure relates to a priority determination system and a priority determination method for determining the priority of response to a vulnerability of a monitoring target.

### BACKGROUND

Patent Literature (PTL) 1 discloses a technique for determining the priority of response to a cyberattack using honeypot observation information.

### Citation List

### Patent Literature

PTL 1: Japanese Patent No. 7311354

### SUMMARY

The system disclosed in PTL 1 can be improved upon.

Therefore, the present disclosure provides a priority determination system and the like capable of improving upon the above related art.

A priority determination system according to the present disclosure includes: a vulnerability information obtainer that obtains vulnerability information concerning a vulnerability of a monitoring target; a honeypot information obtainer that obtains, based on the vulnerability information, configuration information indicating a configuration of a honeypot and observation information obtained from observation performed by the honeypot; an analysis determiner that determines a priority of response to the vulnerability by analyzing the configuration information and the observation information; and an outputter that outputs a result of the determination performed by the analysis determiner.

A priority determination method according to the present disclosure includes: obtaining vulnerability information concerning a vulnerability of a monitoring target; obtaining, based on the vulnerability information, configuration information indicating a configuration of a honeypot and observation information obtained from observation performed by the honeypot; determining a priority of response to the vulnerability by analyzing the configuration information and the observation information; and outputting a result of the determination performed in the determining.

Note that these comprehensive or specific aspects may be implemented by a system, method, integrated circuit, computer program, or recording medium such as a computer-readable compact disc read-only memory (CD-ROM), or by any combination of the system, method, integrated circuit, computer program, and recording medium.

According to the priority determination system and the like in one aspect of the present disclosure, it is possible to improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating an example of a priority determination system according to an embodiment.

FIG. 2 is a flowchart illustrating an example of the operation of the priority determination system according to the embodiment.

FIG. 3 is a diagram illustrating an example of an analysis method for a trend of attacks targeting a vulnerability of a monitoring target.

FIG. 4 is a diagram illustrating another example of the analysis method for a trend of attacks targeting a vulnerability of a monitoring target.

### DESCRIPTION OF EMBODIMENTS

Honeypots corresponding to various services exist, and in the technique disclosed in PTL 1, it is difficult to identify a honeypot that observes an attack targeting a vulnerability of a monitoring target and to obtain observation information of such a honeypot. For this reason, there is a case where an attack targeting a vulnerability of a monitoring target cannot be analyzed, which makes it difficult to determine the priority of response to the vulnerability of the monitoring target. Hereinafter, description is provided on a priority determination system and a priority determination method that can obtain observation information of a honeypot that observes an attack targeting a vulnerability of a monitoring target and can determine the priority of response to the vulnerability of the monitoring target.

Embodiments will be specifically described below with reference to the drawings.

Note that the embodiments described below show comprehensive or specific examples. The numerical values, shapes, materials, components, arrangement positions and connection forms of components, steps, order of steps, and the like shown in the following embodiments are examples and are not intended to limit the present disclosure.

### Embodiment

A priority determination system according to an embodiment will be described below.

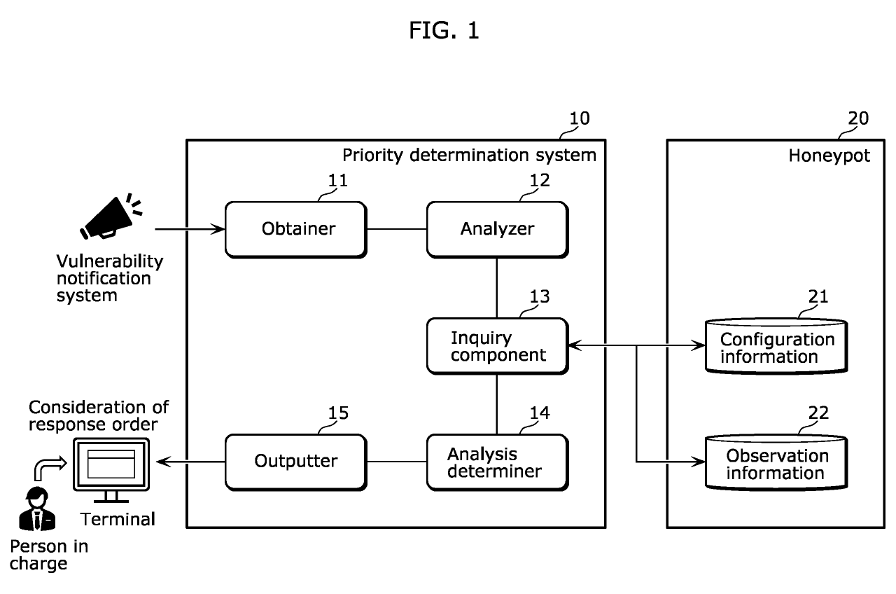

FIG. 1 is a block diagram illustrating an example of priority determination system 10 according to the embodiment. In addition to priority determination system 10, FIG. 1 illustrates a vulnerability notification system that notifies a discovered vulnerability, a terminal operated by a person in charge of responding to vulnerabilities, and honeypot 20.

Priority determination system 10 is a system that determines the priority of response to a vulnerability of a monitoring target. The monitoring target is not particularly limited, but is, for example, a device such as a home appliance or a vehicle, a component included in the device, or software for controlling the device or the component. The number of reports of vulnerabilities may be 100 or more per day, and it may be difficult for a person in charge of a product security incident response team (PSIRT) or the like to determine which vulnerability is to be responded to preferentially. Hereinafter, a description will be given of priority determination system 10 that can determine the priority of response to a vulnerability of a monitoring target in order for a person in charge of a PSIRT or the like to efficiently respond to vulnerabilities.

Priority determination system 10 includes obtainer 11, analyzer 12, inquiry component 13, analysis determiner 14, and outputter 15. Priority determination system 10 includes a storage (not illustrated), and the storage is a computer including a processor (microprocessor), memory, and the like. The memory includes read-only memory (ROM) and random-access memory (RAM), and can store a program to be executed by a processor. Obtainer 11, analyzer 12, inquiry component 13, analysis determiner 14, and outputter 15 are implemented by the processor or the like executing a program stored in the memory.

For example, priority determination system 10 may be a computer (device) in one enclosure or may be a system formed of a plurality of computers. For example, priority determination system 10 may be a server. Note that the components included in priority determination system 10 may be arranged in one server or may be distributed across a plurality of servers.

Obtainer 11 obtains vulnerability information concerning the vulnerability of the monitoring target. Obtainer 11 is an example of a vulnerability information obtainer. For example, obtainer 11 is notified of various vulnerabilities in software of various devices (for example, home appliances or vehicles) from the vulnerability notification system. The vulnerability notification system is not particularly limited, but may be, for example, a security operation center (SOC) or the like. The SOC is an organization that detects, analyzes, and takes countermeasures against cyberattacks. Alternatively, obtainer 11 may obtain vulnerability information from a vulnerability information disclosure database such as the National Vulnerability Database (NVD). Alternatively, obtainer 11 may obtain vulnerability information from software including a vulnerability management and notification function, such as a Software Composition Analysis (SCA) tool. For example, the vulnerability information may include information concerning a name or port number of software that may be a target of a possible cyberattack targeting the vulnerability, risk information such as Common Vulnerability Scoring System (CVSS) information, or response priority information. Note that the risk information may be used as the initial value of the response priority information. The risk information may also be information using the Exploit Prediction Scoring System (EPSS) provided by the Forum of Incident Response and Security Teams (FIRST), or Known Exploited Vulnerabilities (KEV) information provided by the Cybersecurity and Infrastructure Security Agency (CISA).

Analyzer 12 analyzes the vulnerability information. Details of analyzer 12 will be described later.

Based on the vulnerability information, inquiry component 13 obtains configuration information 21 indicating the configuration of honeypot 20 and observation information 22 from observation performed by honeypot 20. Inquiry component 13 is an example of a honeypot information obtainer. Inquiry component 13 communicates with honeypot 20 and inquires of honeypot 20. Details of inquiry component 13 will be described later.

Analysis determiner 14 determines the priority of response to the vulnerability by analyzing configuration information 21 and observation information 22. Details of analysis determiner 14 will be described later.

Outputter 15 outputs a result of the determination performed by analysis determiner 14. For example, outputter 15 outputs the determined priority of response to the vulnerability to a terminal such as a personal computer (PC) operated by a person in charge of responding to vulnerabilities. This enables the person in charge to determine which vulnerability is to be responded to first.

Honeypot 20 is an Internet of Things (IoT) honeypot that is set to be susceptible to a cyberattack and is exposed on the network as a decoy for a cyberattack. This can attract a cyberattack, enabling observation of the cyberattack. Various honeypots corresponding to various types of cyberattacks have been exposed on the network, and FIG. 1 illustrates honeypot 20, which is one of the various honeypots.

For example, configuration information 21 indicating the configuration of honeypot 20 includes a name of software (for example, a Software Bill of Materials (SBOM)) included in honeypot 20, a port number used by the software, a name of a service operating on honeypot 20, geographic information of honeypot 20, an attribute of honeypot 20, or the like. For example, observation information 22 from observation performed by honeypot 20 includes the number of attacks (specifically, communication traffic generated by attacks) on the software included in honeypot 20, operation logs of the software during attacks (specifically, time-stamped logs output by the software upon receipt of attacks), or the like.

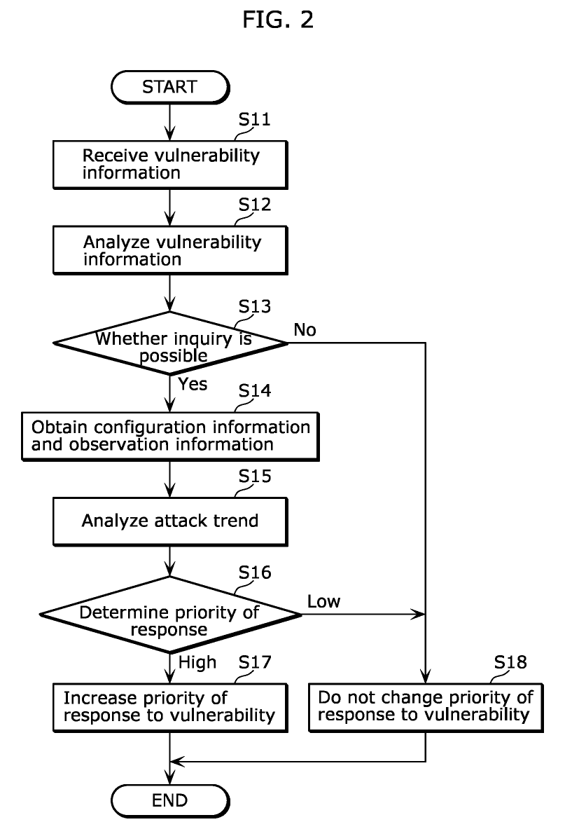

Next, the operation of priority determination system 10 will be described in detail with reference to FIG. 2.

FIG. 2 is a flowchart illustrating an example of the operation of priority determination system 10 according to the embodiment.

First, obtainer 11 receives vulnerability information from the vulnerability notification system (step S11).

Next, analyzer 12 analyzes the vulnerability information (step S12). For example, from the vulnerability information, analyzer 12 extracts information such as software in which the vulnerability has been found or a presumed attack method. Such information serves as identification information for identifying honeypot 20 related to the vulnerability. For example, by extracting software in which the vulnerability has been found as identification information, honeypot 20 including the software can be identified.

Based on the vulnerability information, inquiry component 13 determines whether honeypot 20 can be inquired of, in other words, whether observation information 22 of honeypot 20 can be obtained (step S13). For example, inquiry component 13 determines that honeypot 20 can be inquired of when analyzer 12 has been able to extract identification information, such as a name or port number of software to be an attack target, from the vulnerability information. Obtaining observation information 22 of honeypot 20 may not be possible depending on the content of the obtained vulnerability information, and in such a case, the inquiry to honeypot 20 can be avoided.

When it is determined that honeypot 20 can be inquired of (Yes in step S13), in other words, when it is determined that observation information 22 can be obtained in a case where the identification information has been extracted, inquiry component 13 obtains configuration information 21 and observation information 22 of honeypot 20 (step S14). When it is determined that honeypot 20 cannot be inquired of (No in step S13), inquiry component 13 does not change the priority of response to the vulnerability of the monitoring target (step S18).

For example, as illustrated in FIG. 1, configuration information 21 is stored in honeypot 20, and inquiry component 13 obtains configuration information 21 from honeypot 20 identified based on the identification information. For example, inquiry component 13 transmits the identification information to various honeypots or to a management device or the like managing various honeypots, thereby inquiring whether there is honeypot 20 corresponding to the identification information (for example, honeypot 20 equipped with software to be an attack target). When there is honeypot 20 corresponding to the identification information, inquiry component 13 makes an inquiry to honeypot 20 or to the management device managing honeypot 20, requesting configuration information 21 and observation information 22 of honeypot 20, and obtains configuration information 21 and observation information 22 of honeypot 20. Note that the inquiry as to whether there is honeypot 20 corresponding to the identification information and the inquiry requesting configuration information 21 and observation information 22 of honeypot 20 may be performed simultaneously.

Note that inquiry component 13 may request configuration information 21 from various honeypots or from the management device or the like managing various honeypots, use obtained configuration information 21 to identify honeypot 20 corresponding to configuration information 21 including the identification information, and make an inquiry to identified honeypot 20 or to the management device managing honeypot 20, requesting observation information 22 of honeypot 20, thereby obtaining observation information 22 of honeypot 20. Note that configuration information 21 may be stored in the management device managing honeypot 20.

Note that configuration information 21 may be stored in the storage included in priority determination system 10, and inquiry component 13 may obtain configuration information 21 including the identification information from the storage. Thus, inquiry component 13 can identify honeypot 20 corresponding to obtained configuration information 21, and can make an inquiry to identified honeypot 20 or to the management device managing honeypot 20, requesting observation information 22 of honeypot 20, thereby obtaining observation information 22 of honeypot 20. As described above, configuration information 21 of each of various honeypots may be stored in advance in the storage of priority determination system 10, and inquiry component 13 may obtain configuration information 21 of honeypot 20 from the storage.

Note that the terms “including the identification information” and “corresponding to the identification information” do not necessarily mean including all of the identification information or corresponding to all of the identification information, but may include cases where only a part of the identification information is included or only a part is corresponded to.

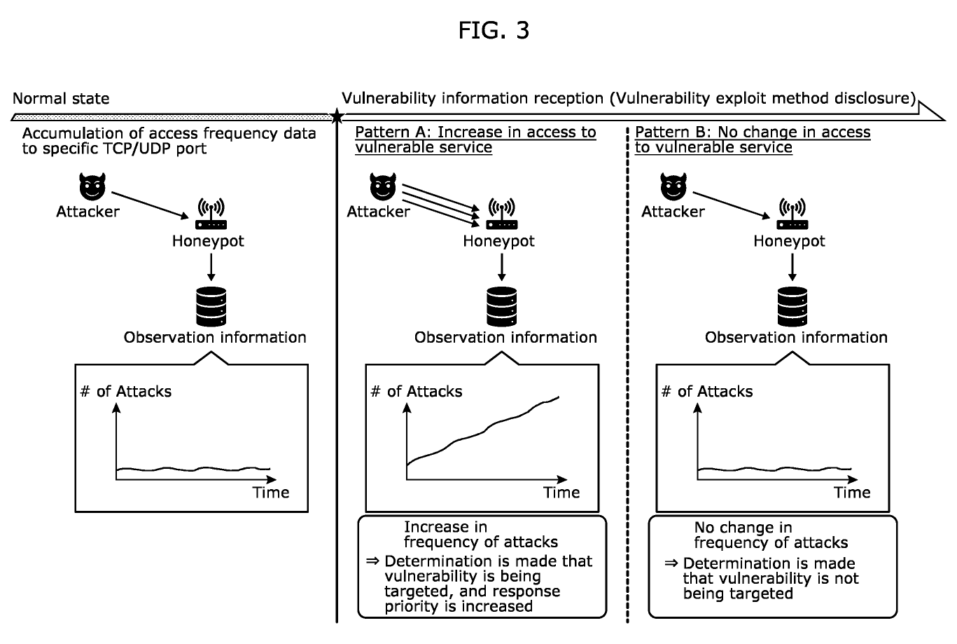

Next, analysis determiner 14 analyzes configuration information 21 and observation information 22 to analyze a trend of attacks targeting the vulnerability of the monitoring target (step S15), and determines the priority of response to the vulnerability (step S16). For example, when analysis determiner 14 determines that communication traffic, which is generated by attacks presumed to be attributable to the vulnerability of the monitoring target, is increasing in observation information 22 of honeypot 20, analysis determiner 14 determines that the priority of response to the vulnerability of the monitoring target is high. Details of the operation of analysis determiner 14 will be described here with reference to FIG. 3.

FIG. 3 is a diagram illustrating an example of an analysis method for a trend of attacks targeting the vulnerability of the monitoring target. The left side of FIG. 3 illustrates an example of observation information 22 of honeypot 20 in a normal state, and the center and right sides illustrate examples of observation information 22 of honeypot 20 after the vulnerability information of the monitoring target is obtained (that is, after an exploit method for the vulnerability is disclosed).

As illustrated on the left side of FIG. 3, it is assumed that, in a normal state, for example, before a vulnerability is found that causes a Transmission Control Protocol (TCP)/User Datagram Protocol (UDP) port having a specific port number as the monitoring target to become an attack target, access frequency (that is, communication traffic) to the port is low. Then, priority determination system 10 obtains the vulnerability information. When observation information 22 of honeypot 20 related to the vulnerability indicated by the vulnerability information indicates an increase in access to a service performed using the port (vulnerable service), as in pattern A illustrated in the center of FIG. 3, analysis determiner 14 determines that the vulnerability of the monitoring target is being targeted due to an increase in the frequency of attacks on the port, and increases the priority of response to the vulnerability of the monitoring target (step S17). On the other hand, when observation information 22 of honeypot 20 related to the vulnerability indicated by the vulnerability information indicates no change in access to the vulnerable service, as in pattern B illustrated on the right side of FIG. 3, analysis determiner 14 determines that the vulnerability of the monitoring target is not being targeted due to no change in the frequency of attacks on the port, and does not change the priority of response to the vulnerability of the monitoring target (step S18).

In the process in step S16, when the priority of response to the vulnerability of the monitoring target has not been obtained or set in advance, the priority of response may be set to “high priority” instead of increasing the priority of response.

As described above, when communication traffic generated by attacks presumed to be attributable to the vulnerability of the monitoring target is increasing, the priority of response to the vulnerability can be increased, since attacks targeting the vulnerability are considered to be increasing.

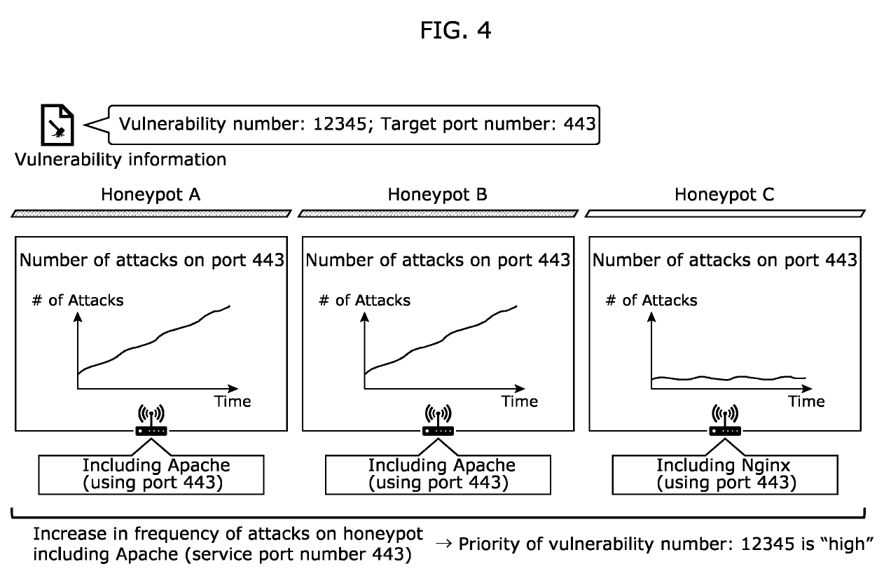

Note that there is a case where different software uses the same port number. In this case, observation information 22 of different honeypot 20 equipped with the different software may be obtained. The operation of analysis determiner 14 in this case will be described with reference to FIG. 4.

FIG. 4 is a diagram illustrating another example of the analysis method for a trend of attacks targeting the vulnerability of the monitoring target. For example, it is assumed that vulnerability number 12345 and attack target port number 443 are extracted from the vulnerability information, and observation information 22 of each of honeypots A to C, which serves as honeypot 20 equipped with software using port 443, is obtained. The left side of FIG. 4 illustrates observation information 22 of honeypot A, the center of FIG. 4 illustrates observation information 22 of honeypot B, and the right side of FIG. 4 illustrates observation information 22 of honeypot C.

As illustrated on the left side and center of FIG. 4, the frequency of attacks on port 443 is increasing in observation information 22 of honeypots A, B, but as illustrated on the right side of FIG. 4, the frequency of attacks on port 443 remains unchanged in observation information 22 of honeypot C. Thus, analysis determiner 14 may not be able and determines the priority of response to the vulnerability of the monitoring target from obtained observation information 22 of each of honeypots A to C. Therefore, analysis determiner 14 analyzes configuration information 21. For example, when configuration information 21 includes the name of the software included in honeypot 20 and the vulnerability of the monitoring target is related to “Apache”, it can be determined that observation information 22 for determining the priority of response to the vulnerability of the monitoring target is not observation information 22 of honeypot C including “Nginx” but observation information 22 of honeypots A, B including “Apache”. Therefore, it can be determined that the priority of response to the vulnerability of the monitoring target with vulnerability number 12345 is high.

When the monitoring target is used in a specific location and configuration information 21 includes the geographic information of honeypot 20, the priority of response to the vulnerability of the monitoring target can be determined using observation information 22 of honeypot 20 having configuration information 21 that includes the geographic information indicating the specific location. When the monitoring target has a specific attribute (for example, an attribute for automobiles, home appliances, or the like) and configuration information 21 includes the attribute of honeypot 20, the priority of response to the vulnerability of the monitoring target can be determined using observation information 22 of honeypot 20 having configuration information 21 that includes the specific attribute. When the monitoring target is used for a specific service and configuration information 21 includes the name of the service operating on honeypot 20, the priority of response to the vulnerability of the monitoring target can be determined using observation information 22 of honeypot 20 having configuration information 21 that includes the name of the specific service.

Thus, it may be difficult to determine the priority of response to the vulnerability of the monitoring target only from observation information 22, but in such a case, the priority of response to the vulnerability of the monitoring target can be determined by further analyzing configuration information 21.

As described above, since configuration information 21 of honeypot 20 is obtained based on vulnerability information concerning the vulnerability of the monitoring target, honeypot 20 related to the vulnerability of the monitoring target can be identified, and the priority of response to the vulnerability of the monitoring target can be determined from observation information 22 of identified honeypot 20 observing an attack targeting the vulnerability of the monitoring target. This enables the person in charge of the PSIRT or the like to respond to vulnerabilities starting with one having a high priority of response, thereby reducing the cost of the PSIRT or the like and reducing the occurrence of a serious incident due to a missed response to a serious vulnerability. For example, the person in charge of the PSIRT or the like can efficiently respond to a vulnerability of a shipped vehicle as a monitoring target.

### Other Embodiments

As described above, the embodiment has been described as an example of the technique according to the present disclosure. However, the technique according to the present disclosure is not limited thereto, and can be appropriately applied to embodiments with modifications, substitutions, additions, omissions, and the like. For example, the following variations are also included in one embodiment of the present disclosure.

For example, inquiry component 13 may further obtain a result of analysis performed by the SOC on the vulnerability of the monitoring target, and analysis determiner 14 may analyze configuration information 21 and observation information 22 of honeypot 20, as well as the analysis result from the SOC, to determine the priority of response to the vulnerability of the monitoring target.

By analyzing the analysis result from the SOC in addition to observation information 22 of identified honeypot 20, the priority of response to the vulnerability of the monitoring target can be determined with higher accuracy. Note that inquiry component 13 may obtain an analysis result from a vulnerability analysis system different from the SOC, and analysis determiner 14 may use the analysis result from the vulnerability analysis system different from the SOC for determining the priority of response to the vulnerability of the monitoring target.

For example, an example has been described in the above embodiment in which inquiry component 13 determines, based on the vulnerability information, whether observation information 22 can be obtained. However, inquiry component 13 may not determine whether observation information 22 can be obtained.

For example, an example in which priority determination system 10 includes analyzer 12 has been described, but priority determination system 10 may not include analyzer 12.

For example, the present disclosure can be implemented not only as priority determination system 10, but also as a priority determination method including steps (processes) performed by the components constituting priority determination system 10.

As illustrated in FIG. 2, the priority determination method according to the present disclosure includes: a vulnerability information obtaining step of obtaining vulnerability information concerning a vulnerability of a monitoring target (step S11); a honeypot information obtaining step of obtaining, based on the vulnerability information, configuration information 21 indicating a configuration of honeypot 20 and observation information 22 from observation performed by honeypot 20 (step S14); an analysis determination step of determining a priority of response to the vulnerability by analyzing configuration information 21 and observation information 22 (step S16); and an output step of outputting a result of the determination performed in the analysis determination step (step S17, step S18).

For example, the present disclosure can be implemented as a program for causing a computer (processor) to execute steps included in a priority determination method. Furthermore, the present disclosure can be implemented as a non-temporary computer-readable recording medium such as a CD-ROM on which the program is recorded.

For example, when the present disclosure is implemented by a program (software), each step is performed by executing the program using hardware resources such as a central processing unit (CPU), memory, and input/output circuits of a computer. That is, each step is executed by a CPU obtaining data from memory, input/output circuits, or the like, by performing calculations, or by outputting a calculation result to memory, input/output circuits, or the like.

In the above embodiment, each component included in priority determination system 10 may be formed of dedicated hardware or implemented by executing a software program suitable for the component. Each component may be implemented by a program executor, such as a CPU or a processor, reading and executing a software program recorded in a recording medium such as a hard disk or a semiconductor memory.

Some or all of the functions of priority determination system 10 according to the above embodiment are typically implemented as a large-scale integrated circuit (LSI), which is an integrated circuit. The functions may each be individually integrated into one chip, or may be integrated into one chip so as to include some or all of the functions. The integrated circuitry is not limited to an LSI, but may be implemented by a dedicated circuit or a general-purpose processor. It may also be possible to use a field-programmable gate array (FPGA) that can be programmed after manufacturing of an LSI, or a reconfigurable processor that can reconfigure connections and settings of circuit cells within an LSI.

Furthermore, when integrated circuitry technology that replaces an LSI emerges due to advances in semiconductor technology or another derived technology, the integrated circuitry of each component included in priority determination system 10 may, as a matter of course, be implemented using such technology.

In addition, the present disclosure also includes forms that can be obtained by applying various variations, conceivable by a person skilled in the art, to the embodiments, and forms that can be implemented by arbitrarily combining components and functions in the embodiments without departing from the gist of the present disclosure.

### Note

According to the above description of the embodiments, the following techniques are disclosed.

### Technique 1

A priority determination system including: a vulnerability information obtainer that obtains vulnerability information concerning a vulnerability of a monitoring target; a honeypot information obtainer that obtains, based on the vulnerability information, configuration information indicating a configuration of a honeypot and observation information obtained from observation performed by the honeypot; an analysis determiner that determines a priority of response to the vulnerability by analyzing the configuration information and the observation information; and an outputter that outputs a result of the determination performed by the analysis determiner.

With this configuration, based on vulnerability information concerning a vulnerability of a monitoring target, configuration information of a honeypot is obtained, so that the honeypot related to the vulnerability of the monitoring target can be identified, and the priority of response to the vulnerability of the monitoring target can be determined from the observation information of the identified honeypot that observes an attack targeting the vulnerability of the monitoring target.

### Technique 2

The priority determination system according to technique 1, wherein the honeypot information obtainer determines, based on the vulnerability information, whether the observation information is obtainable, and obtains the configuration information and the observation information when the observation information is determined to be obtainable.

With this configuration, obtaining the observation information of the honeypot may not be possible depending on the content of the obtained vulnerability information, and in such a case, the inquiry to the honeypot can be avoided.

### Technique 3

The priority determination system according to technique 2, further including: an analyzer that analyzes the vulnerability information, wherein the analyzer extracts identification information for identifying the honeypot related to the vulnerability from the vulnerability information, and when the identification information is extracted, the honeypot information obtainer determines that the observation information is obtainable.

With this configuration, when the vulnerability information includes identification information for identifying a honeypot that observes an attack targeting the vulnerability of the monitoring target, the identified honeypot can be inquired of to obtain observation information or the like.

### Technique 4

The priority determination system according to technique 3, wherein the configuration information is stored in the honeypot, and the honeypot information obtainer obtains the configuration information from the honeypot identified based on the identification information.

Thus, the priority determination system may obtain the configuration information from the honeypot.

### Technique 5

The priority determination system according to technique 3, wherein the honeypot information obtainer obtains, from a management device managing the honeypot, the configuration information of the honeypot identified based on the identification information.

Thus, the priority determination system may obtain the configuration information from the management device managing the honeypot.

### Technique 6

The priority determination system according to technique 3, wherein the configuration information is stored in a storage included in the priority determination system, and the honeypot information obtainer obtains, from the storage, the configuration information including the identification information.

Thus, configuration information of each of various honeypots may be stored in advance in the storage of the priority determination system, and the honeypot information obtainer may obtain the configuration information of the honeypot from the storage.

### Technique 7

The priority determination system according to any one of techniques 1 to 6, wherein the configuration information includes a name of software included in the honeypot, a port number used by the software, a name of a service operating on the honeypot, geographic information of the honeypot, or an attribute of the honeypot.

With this configuration, by using a name of software included in the honeypot, a port number used by the software, a name of a service operating on the honeypot, geographic information of the honeypot, or an attribute of the honeypot, the priority of response to the vulnerability of the monitoring target can be determined with higher accuracy.

### Technique 8

The priority determination system according to any one of techniques 1 to 7, wherein the analysis determiner determines that a response priority to the vulnerability is high when communication traffic is determined to be increasing in the observation information, the communication traffic being generated by an attack presumed to be attributable to the vulnerability.

With this configuration, when communication traffic generated by attacks presumed to be attributable to the vulnerability of the monitoring target is increasing, the priority of response to the vulnerability can be increased, since attacks targeting the vulnerability are considered to be increasing.

### Technique 9

The priority determination system according to any one of techniques 1 to 8, wherein the honeypot information obtainer further obtains an analysis result from analysis performed on the vulnerability by a security monitoring and analysis system, and the analysis determiner analyzes the configuration information, the observation information, and the analysis result and determines the priority of response to the vulnerability.

With this configuration, by analyzing an analysis result from a security monitoring and analysis system such as an SOC in addition to the observation information of the identified honeypot, the priority of response to the vulnerability of the monitoring target can be determined with higher accuracy.

### Technique 10

A priority determination method including: obtaining vulnerability information concerning a vulnerability of a monitoring target; obtaining, based on the vulnerability information, configuration information indicating a configuration of a honeypot and observation information obtained from observation performed by the honeypot; determining a priority of response to the vulnerability by analyzing the configuration information and the observation information; and outputting a result of the determination performed in the determining.

Accordingly, it is possible to provide a priority determination method that can obtain observation information of a honeypot capable of observing an attack targeting a vulnerability of a monitoring target and can determine the priority of response to the vulnerability of the monitoring target.

### Further Information about Technical Background to this Application

The disclosure of the following patent application including specification, drawings, and claims is incorporated herein by reference in their entirety: Japanese Patent Application No. 2024-193032 filed on November 01, 2024.

### Industrial Applicability

The present disclosure is applicable to a system for responding to a vulnerability, and the like.

1. A priority determination system comprising:
a vulnerability information obtainer that obtains vulnerability information concerning a vulnerability of a monitoring target;
a honeypot information obtainer that obtains, based on the vulnerability information, configuration information indicating a configuration of a honeypot and observation information obtained from observation performed by the honeypot;
an analysis determiner that determines a priority of response to the vulnerability by analyzing the configuration information and the observation information; and
an outputter that outputs a result of the determination performed by the analysis determiner.

2. The priority determination system according to claim 1, wherein the honeypot information obtainer determines, based on the vulnerability information, whether the observation information is obtainable, and obtains the configuration information and the observation information when the observation information is determined to be obtainable.

3. The priority determination system according to claim 2, further comprising: an analyzer that analyzes the vulnerability information, wherein the analyzer extracts identification information for identifying the honeypot related to the vulnerability from the vulnerability information, and when the identification information is extracted, the honeypot information obtainer determines that the observation information is obtainable.

4. The priority determination system according to claim 3, wherein the configuration information is stored in the honeypot, and the honeypot information obtainer obtains the configuration information from the honeypot identified based on the identification information.

5. The priority determination system according to claim 3, wherein the honeypot information obtainer obtains, from a management device managing the honeypot, the configuration information of the honeypot identified based on the identification information.

6. The priority determination system according to claim 3, wherein the configuration information is stored in a storage included in the priority determination system, and the honeypot information obtainer obtains, from the storage, the configuration information including the identification information.

7. The priority determination system according to claim 1, wherein the configuration information includes a name of software included in the honeypot, a port number used by the software, a name of a service operating on the honeypot, geographic information of the honeypot, or an attribute of the honeypot.

8. The priority determination system according to claim 1, wherein the analysis determiner determines that a response priority to the vulnerability is high when communication traffic is determined to be increasing in the observation information, the communication traffic being generated by an attack presumed to be attributable to the vulnerability.

9. The priority determination system according to claim 1, wherein the honeypot information obtainer further obtains an analysis result from analysis performed on the vulnerability by a security monitoring and analysis system, and the analysis determiner analyzes the configuration information, the observation information, and the analysis result and determines the priority of response to the vulnerability.

10. A priority determination method comprising: obtaining vulnerability information concerning a vulnerability of a monitoring target; obtaining, based on the vulnerability information, configuration information indicating a configuration of a honeypot and observation information obtained from observation performed by the honeypot; determining a priority of response to the vulnerability by analyzing the configuration information and the observation information; and outputting a result of the determination performed in the determining.
